(19) United States
(12) Patent Application Publication
(10) Pub. No.: US 2020/0269406 A1
(43) Pub. Date: Aug. 27, 2020

(54) Nail with aperture for hanging and supporting

(71) Applicant: Gretchen Elizabeth Homme, Anoka, MN (US)

(72) Inventor: Gretchen Elizabeth Homme, Anoka, MN (US)

(21) Appl. No.: 16/799,666

(22) Filed: Feb. 24, 2020

Related U.S. Application Data
(60) Provisional application No. 62/919,037, filed on Feb. 25, 2019.

(51) Int. Cl. B25C 3/00; B25C 1/00; B25C 7/00

(52) U.S. Cl. CPC B25C 3/008; B25C 7/00; B25C 1/005

(57) ABSTRACT

A fastening device for supporting, hanging, holding and threading, includes: a shank with an aperture formed therethrough which can but doesn't have to include a built up area of material around it. The shank has two ends one end (head) is configured to be driven into by a driving tool such as a hammer, for securing the second pointed end into a member for securing the shank therewithin.

### CROSS-REFERENCE TO RELATED APPLICATIONS

The present application is based on and claims the benefit of U.S. provisional patent application Ser. No. 62/919,037, filed Feb. 25, 2019, the content of which is hereby incorporated by reference in its entirety.

### FIELD

This disclosure relates to the field of mounting devices. More specifically it relates to a nail or screw having an aperture for threading, hanging, holding and supporting objects.

### BACKGROUND

Various mounting devices have been developed in the past to build, attach or fasten devices together. For example, the common nail or screw. The screw was patented on Jan. 11, 1921. It is a fastener having a screw on one end which provides an improved means for supporting a hook, hanger, or the like, on the other end.

There are various screws, eyes and hooks that are disclosed in U.S. Pat. No. 293,079 patented on Feb. 5, 1884 to Pope, each having various eye hooks which are either open or closed and other fastening devices none of which could be easily installed.

Many of the fastening devices on the market do not offer immediate use of the product. Such as the adhesive backed hooks where the wall has to be prepared first and there is a waiting period before use.

Some of these fastening devices (like hook devices) do not offer a high level of support to contain or isolate a particular threaded item.

There is a device on the market called the Drive Screw Eye Hook which has a threaded end like a screw that rotates into the surface. It uses a rotating driving tool that rotates like a screwdriver. Sometimes a screw ending is not desired to put into a surface but alternatively a nail ending is preferred. Each job is different and some jobs are better suited to use a nail like ending in a surface verses a screw especially when the fastener will bear more side-to-side movement or needs some give, a nail is the better choice.

Additionally, at times it is desirable to use a driving tool like a hammer over a rotating driving tool like a screwdriver as a preference. So there needs to be an option as to what driving tool is used. A driving tool such as a hammer is a common tool that most people have on hand unlike having to find a specific screw and screwdriver for application.

The Drive Screw Eye Hook and the other hooks including those attached to tape, eyes and other fastening devices that are currently on the market are not appealing to look at. You can't line several of them up near each other and thread something through them to go in different (vertically, horizontally and diagonally, upside down or in any direction) and also have a uniform, appealing look to them. The nail with an aperture device when applied has an aesthetic quality.

What is clearly needed is a mounting, fastening, supporting and threading device like the nail with aperture device that not only does it have an appealing look to it when applied it solves all the problems above at the same time. This is an important tool for a variety of people groups such as: electricians, builders, Crafters, decorators, and more.

### SUMMARY

In one embodiment of the invention a fastening device for supporting, hanging, holding and threading, is provided comprising a shank with an aperture formed therethrough, the shaft has two ends one end (head) is configured to be driven into by a driving tool such as a hammer or a screwdriver, for securing the second pointed end into a member for securing shank therewithin.

Also, in one embodiment a support of a built up area of material on the shank of the device, which can be composed of the same material that the shank is composed of or made of an a different material that is added to the shank, with an aperture formed therethrough.

In another aspect of the invention a fastening device for supporting, hanging and holding or threading is provided comprising: a built up head with an aperture formed therethrough, the head can be formed from the same or different material as the shank is composed of. The shank has two ends one end is embedded in the build up head that is configured to be driven into by a driving tool or by force, for securing the second pointed narrow end (i.e. tack) into a member for securing shank therewithin.

### BRIEF DESCRIPTION OF THE DRAWINGS

These items are not made to scale so as to more clearly show the details wherein like reference as to more clearly show the details, wherein like references numbers indicate like elements throughout several figures. Further features, aspects and advantages of the present disclosure will become better understood by reference to the following figures wherein detailed description, appended claims and accompanying figures, wherein elements are not to scale so as to more clearly show the details, wherein like reference numbers indicate like elements throughout the several views, and wherein:

FIG. 1 is a frontal view of the fastening, supportive device with aperture according to the embodiment of this present invention.

FIGS. 2A and 2B respectively are a top view (when looking at it directly fastened into a structure) of a single fastening supportive device with aperture of FIG. 1 or this present invention, and a top view of multiple devices together.

FIGS. 3A and 3B are frontal views of examples of the fastening supportive device with a build up area of material to provide possible support but also to provide a stopping point for shaft entry into material around the aperture formed therethrough to a further embodiment of the present version.

FIG. 4 is a frontal view of the fastening device with aperture that resembles most closely to a tack in that it has a narrow thin shaft or body, the head part of the device is where the aperture is located).

FIG. 5 illustrates a front view of a fastening device having features of a screw and top views of a head of the fastening device, in accordance with embodiments of the present disclosure.

### DETAILED DESCRIPTION OF ILLUSTRATIVE EMBODIMENTS

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

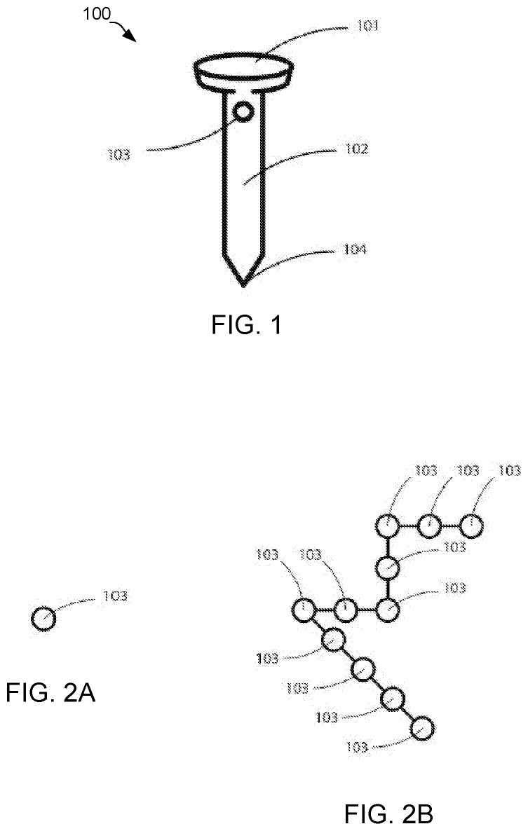

The inventor provides a unique mounting system; a fastener with aperture with nail pointed end is used 100 (FIG. 1) for supporting, hanging, or holding threaded items. A fastener device 100 is made up of a nail head 101 which is the area that a driving tool (such as a hammer) hits and drives the said device into the material. The nail head can be convex, concave or flat on top, and it can be any shape i.e. circular, star, flower that can provide a uniform look when applied. The shank 102 of the device has an aperture 103 formed therethrough (this is where items are threaded through such as cords, wire or plastic string etc. to be hung, held or are supported. The aperture is located midline on the shaft. (The opening can vary in size depending on the tasks needed and the shaft size. It is located within the top half of the shank most often close to the head.

The point 104 is at the end opposite the 101 head of the said device and it is usually sharp and pointed to easily penetrate the material when the 101 head is pounded by the driving tool. Referring now to FIGS. the numeral 100 indicates generally the fastening device of the present invention.

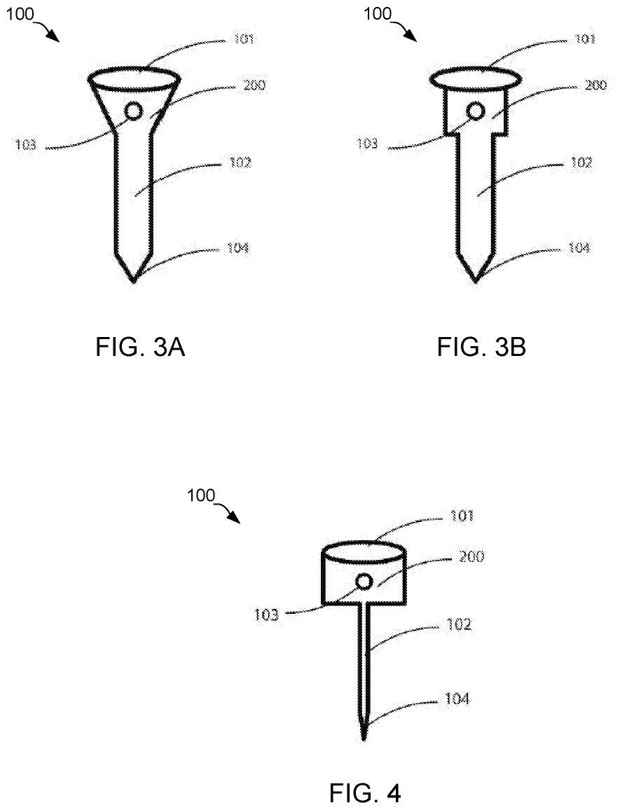

FIG. 2A is a top view of the fastener device 100 embodiment of FIG. 1, and FIG. 2B illustrates a configuration of multiple faster devices 100. Top view of the head 101 of the device when applied to the surface. The head 101 is the area that a driving tool (such as a hammer) hits and drives the fastener device 100 into the material. The head 101 can be convex, concave or flat on top. The view is 101 A top view of a singular 100 device after applied into material and 101 B top view of multiple 100 devices after threading. They are uniform as the aperture can be turned any direction. The head can be broad as to be the grabbing area of a device such as a hammer claw to easily remove it from the surface or it can be smaller and just be the top of a built of area of the shaft as will be described in FIGS. 3A-B, is a frontal view of FIG. 1 embodiment of device 100 that alternatively may include a support or a 200 built up area of material on a 102 shank of the device which can be composed of the same material that the shank is composed of or made of a different material that is added to the shank with an 103 aperture formed therethrough.

The built up area or thickened area of material 200 shown in FIGS. 3A and 3B provides a stopping point so that the shank will not penetrate the material any further when 100 is driven by a driving tool.

This build up Area or thickened area 200 can be any shape. In FIG. 3A the removal of the fastener device 100 could be removed at the point where the built up area 200 is narrowed. Or it could be removed by 101 a broadened head as stated above or as in FIG. 3B, where the built up area 200 could be square or rectangular shaped mainly there as a stop area so that when driven by the driving tool the shaft will not penetrate past the built up area 200. The shape of this build up area would enforce that the removing tool device would not remove this after the built up area ends at the narrow area 200 as in FIG. 3A but at the broadened head 101 on top of the built up area 200.

FIG. 4 A fastener device 100 most resembling a tack is made up of a head 101 head, that is broad to allow an aperture 103 formed therethrough. The aperture 103 runs midline the head. The head 101 is the area where a driving tool or hand manually thrusts or pushes to drive the device into the material. The nail head 101 can be convex, concave or flat on top and it can be any shape i.e circular, star, flower shaped etc. The head 101 can be made of the same material as the shank 102 or made of different material. The shank is like that of a tack. It is very narrow and pointed. The point 104 is at the end opposite the head of the said device and it is usually sharp and pointed to easily go into the material when the head is pushed manually or pounded by the driving tool. The nail with aperture device 100 of the present disclosure advantageously allows items to be held, supported and threaded between themselves.

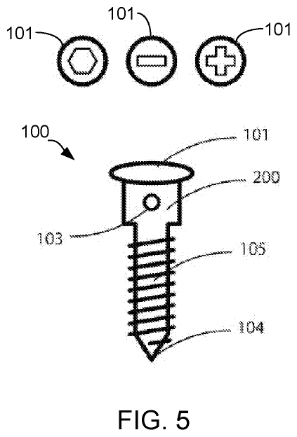

FIG. 5 illustrates a fastener device 100 having features of a screw and top views of a head 101 of the device 100. The fastener device 100 of FIG. 5 may include similar features to the embodiments described above, but with the addition of a threaded shank 105, which may be screwed into desired material, such as using a screwdriver, to secure the fastener device 100 to the material. The head 101 may include sockets for interfacing with conventional tools (e.g., screwdriver, hex key, etc.) to rotate the fastener device 100 and drive it into the material, as illustrated in the top views of the head 101.

The forgoing description of preferred embodiments of the present disclosure have been presented for purposes of illustration and description. The described preferred embodiments are not intended to be exhaustive or to limit the scope of the disclosure to the precise forms disclosed. Obvious modifications or variations are possible in light of the above teachings.

1. A fastening device for supporting, hanging, holding and threading, comprising: a shank with an aperture formed therethrough; the shank has two ends one end (head) is configured to be driven into by a driving tool such as a hammer for securing; the second pointed end into a member for securing shank therewithin.

2. The fastening device of claim 1 further comprising: a support of a built up area of material on the shank of the device, which can be composed of the same material that the shank is composed of or made of a different material that is added to the shank, with an aperture formed therethrough.

3. A fastening device for supporting, hanging and holding or threading comprising: a built up head with an aperture formed therethrough, the head can be formed from the same or different material as the shank is composed of. The shank has two ends one end is embedded in the build up head that is configured to be driven into by a driving tool or by force, for securing the second pointed narrow end i.e tack) into a member for securing shank therewithin.
